(19) United States
(12) Patent Application Publication
(10) Pub. No.: US 2009/0168407 A1
(43) Pub. Date: Jul. 2, 2009

(54) LIGHTING MECHANISM

(76) Inventor: Clifford Wright, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/245,621

(22) Filed: Oct. 3, 2008

Related U.S. Application Data
(60) Provisional application No. 60/978,050, filed on Oct. 5, 2007.

(51) Int. Cl. F21V 33/00; F21V 21/08; F21L 4/02

(52) U.S. Cl. 362/103; 362/184

(57) ABSTRACT

A lighting mechanism includes a housing having a horizontal array of lights, the horizontal array of lights being mounted to pivot vertically. The housing contains a power source for the horizontal array of lights. The housing is connected to a base to allow the housing and the horizontal array of lights to pivot horizontally.

### REFERENCE TO PRIORITY DOCUMENT

This application claims priority of co pending U.S. Provisional Patent Application Ser. No. 60/978,050, filed on Oct. 5, 2007. The disclosure of the Provisional Patent Application is hereby incorporated by reference in its entirety.

### BACKGROUND

The present disclosure relates to a lighting mechanism. More particularly the present disclosure relates to a portable lighting mechanism that can be mounted, for example, in a glove.

A variety of gloves are used for protection in a number of activities such as sports, construction and gardening. People wear gloves to protect their hands from scratches or cuts resulting from a fall. Aside from the utilitarian feature of protecting a wearer's hand, most gloves serve no other purpose.

A person will often wear a glove while performing a task, such as while repairing a mechanical item. The task is often performed in an area where lighting is minimal. The person is then required to aim a light source, such as a flash light, at the work area. This can be unwieldy as it requires the person to hold the flash light while also performing the separate mechanical repair. In view of the foregoing, there is a need for an improved light device.

### SUMMARY

This document discloses a lighting mechanism that can be easily handled and that can be mounted in or on a variety of locations. In an embodiment, the lighting mechanism includes aimable lights that can be pivoted up and down as well as side-to-side, and which are self-contained within a single housing that can be mounted on any object, such as a glove, clothing, an accessory such as a bracelet, or an article such as a bicycle.

In one aspect, a lighting mechanism includes a housing having a horizontal array of lights, the horizontal array of lights being mounted to pivot vertically. The housing contains a power source for the horizontal array of lights. The housing is connected to a base to allow the housing and the horizontal array of lights to pivot horizontally.

In another aspect, a lighting mechanism includes a housing having a subsection provided at a boundary of the housing. The subsection contains a set of lights and being adapted to pivot up and down with respect to the housing. The housing further includes a power source connected to power the set of lights. The housing is mounted to a base that allows the housing to rotate side-to-side with respect to the base.

In another aspect, there is disclosed a lighting mechanism comprising: a main housing; a subsection attached to the housing, the subsection being pivotably mounted on the housing about a horizontal axis such that the subsection can rotate vertically about the horizontal axis; an array of lights positioned on the subsection; a power source in the housing adapted to power the array of lights; and a base movably attached to the main housing, wherein the main housing can rotate relative to the base about a vertical axis

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a side perspective view of a lighting mechanism.

FIG. 2 is a front perspective view of a lighting mechanism.

FIG. 3 is a cutaway view of a lighting mechanism.

FIG. 4 depicts a lighting mechanism attached to a glove.

### DETAILED DESCRIPTION

This document describes a lighting mechanism including a set of lights and a power source in a common housing. Part of the housing is adapted to pivot vertically, such that the set of lights illuminate in a direction that ranges from horizontal to vertical from the major axis of the housing. In some implementations, the set of lights are arranged as a horizontal array of lights along a side of the housing.

Before the present subject matter is further described, it is to be understood that this subject matter described herein is not limited to particular embodiments described, as such may of course vary. It is also to be understood that the terminology used herein is for the purpose of describing particular embodiments only, and is not intended to be limiting. Unless defined otherwise, all technical terms used herein have the same meaning as commonly understood by one skilled in the art to which this subject matter belongs.

As will be apparent to those of skill in the art upon reading this disclosure, each of the individual embodiments described and illustrated herein has discrete components and features which may be readily separated from or combined with the features of any of the other several embodiments without departing from the scope of the subject matter described herein. Any recited method can be carried out in the order of events recited or in any other order which is logically possible.

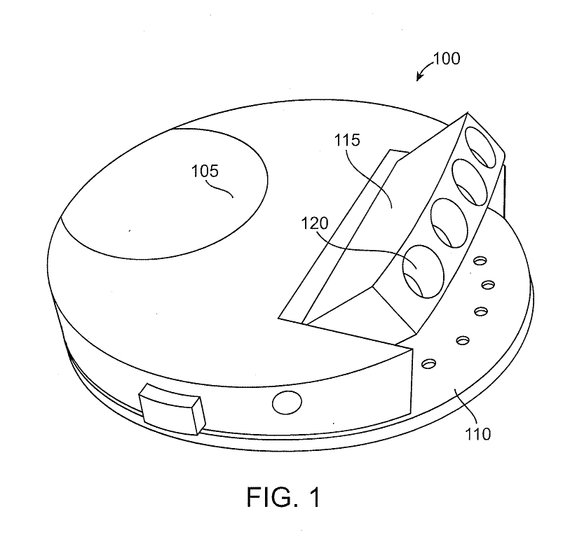

In some implementations, as illustrated in FIGS. 1-3, a set of lights includes four lights arranged horizontally along a side of the housing, in a subsection of the housing that pivots independently of the rest of the housing. The subsection is connected on ends by a hinge or other pivoting mechanism, that allows the subsection to pivot such that the set of lights illuminates in a direction ranging from horizontal to vertical with respect to the major axis of the housing.

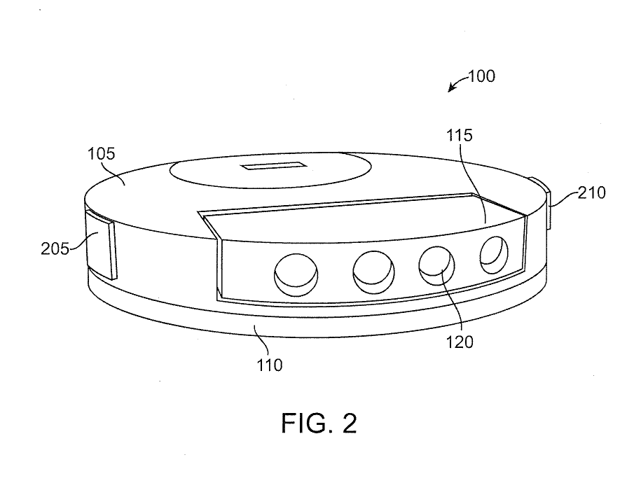

FIG. 1 is a side perspective view of an exemplary embodiment of the lighting mechanism 100. FIG. 2 shows a front perspective view of the lighting mechanism 100. The lighting mechanism 100 includes a main housing 105 that is rotatably mounted on a base 110. In an embodiment, the main housing 105 can be detached and re-attached to the base 110. The main housing 105 includes a movable subsection 115 having one or more lights 120. In an embodiment, the lights 120 are arranged in a horizontal array of lights. The main housing 105 and base 110 are circular or cylindrical in shape although it should be appreciated that the shape can vary.

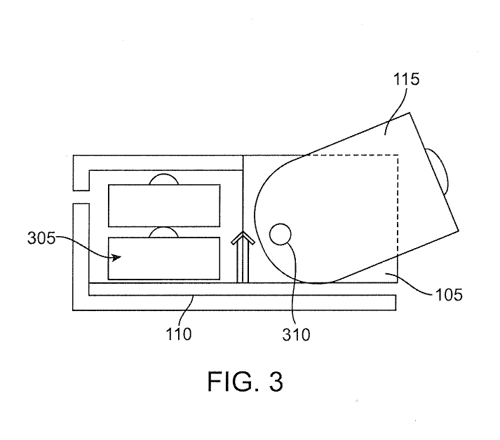

The subsection 115 is movably attached to the main housing 105. In this regard, the subsection 115 is pivotably attached to the main housing such that the subsection 115 (and the lights 120) can rotate vertically to vary the vertical direction in which the lights 120 are pointing. In an embodiment, the subsection 115 rotates about a horizontal axis with the base 110 being aligned along a horizontal plane. As shown in the cross-sectional view of FIG. 3, a pivot pin 310 can be used to pivotably attach the subsection 115 to the housing 105.

FIG. 3 shows a cross-sectional view of the lighting mechanism 100 from the side. The housing 105 includes at least one power source 305 for powering the set of lights 120. The power source 305 can include one or more batteries, such as lithium or nickel cadmium. Alternatively, the housing 105 can include a solar energy source having one or more solar panels. The housing 105 is mounted to the base which allows the housing to pivot about a vertical, or minor, axis. In some implementations, the housing can pivot up to 90 degrees in either direction from a starting direction.

The housing 105 can include one or more actuators. For example, as shown in FIG. 2, a first button 205 on the side of the housing 105 can be activated to release the housing 105 from being stationary on the base 110 and to pivot. That is, when the button 205 is in a first position, the housing 105 is locked relative to the base 110 such that the housing 105 can't move relative to the base. When the button 205 is in a second position, the housing 105 is free to rotate about an axis that is perpendicular to the base 110. This permits the orientation of the lights 120 to be adjusted. A second button 210 on the side of the housing 105 can be activated to control the set of lights 120. In some implementations, the first and second buttons can protrude from a side of the housing. Alternatively, one or both of the buttons can be a touch-sensitive area on the housing. Other actuation mechanisms can also be used.

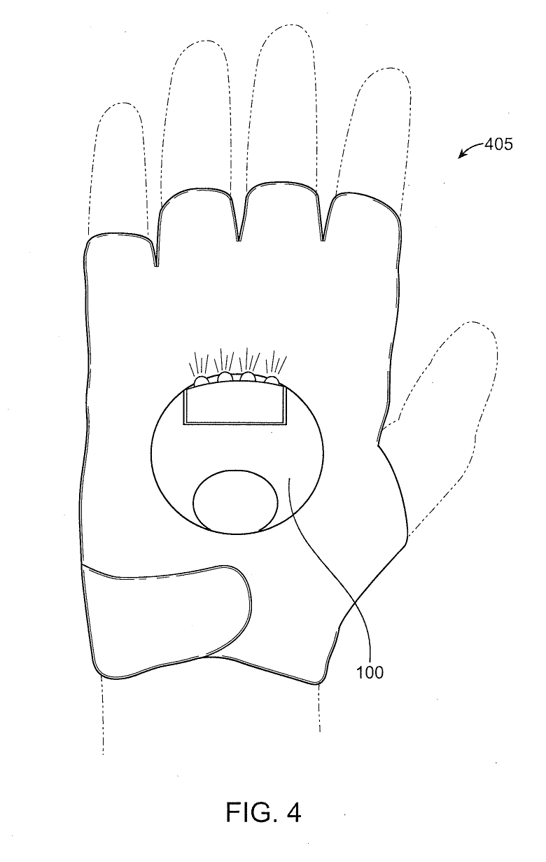

The base 110 can be mounted to any of a number of objects. The base 110 can include any of a variety of means for attaching the base 110 to the objects. For example, the base 110 can include adhesive, screws, magnets, etc. FIG. 4 depicts a lighting mechanism 100 mounted to a glove 405, and more particularly to a part of the glove that is adapted to cover the back of a wearer's hand. The base 110 of the lighting mechanism can be sewn or otherwise attached to the glove (such as using a magnetic attachment), to enable a user to illuminate an area in a desired direction. The illuminated direction can be changed by pivoting the subsection 115 of the housing 110 up or down from the rest of the housing 110, or by rotating the housing 110 relative to the base 110.

The lighting mechanism housing can be made of plastic or other rigid, durable material. The lights can be halogen, light emitting diodes, or incandescent lamps, or other light source. The housing can include a removable cover for access to the power supply, i.e. to insert or remove the batteries. In some implementations, the housing and subsection can be formed to create a low-profile cylinder. In other implementations, the housing can have rounded edges and sides. Those having skill in the art will recognize, however, that the housing and subsection for the set of lights can be of any shape or dimensions.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although a few embodiments have been described in detail above, other modifications are possible. Other embodiments may be within the scope of the following claims.

What is claimed:

1. A lighting mechanism comprising:
a main housing;
a subsection attached to the housing, the subsection being pivotably mounted on the housing about a horizontal axis such that the subsection can rotate vertically about the horizontal axis;
an array of lights positioned on the subsection;
a power source in the housing adapted to power the array of lights;
a base movably attached to the main housing, wherein the main housing can rotate relative to the base about a vertical axis.

2. A lighting mechanism as in claim 1, wherein the array of lights comprises a plurality of lights arranged in a horizontal row.

3. A lighting mechanism as in claim 1, further comprising a magnet in the base.

4. A lighting mechanism as in claim 1, wherein the subsection pivot up to a range of 90 degrees about the horizontal axis.

5. A lighting mechanism as in claim 1, wherein the array of lights comprises light emitting diodes.

6. A lighting mechanism as in claim 1, wherein the main housing locks in a fixed position relative to the base.

7. A lighting mechanism as in claim 1, further comprising a glove, wherein the base is attached to the glove.

8. A lighting mechanism as in claim 1, wherein the base is attached to a portion of the glove that covers a back of a wearer's hand.

9. A lighting mechanism comprising:
a housing having a subsection provided at a boundary of the housing, the subsection containing a set of lights and being adapted to pivot up and down with respect to the housing, the housing further including a power source connected to power the set of lights, the housing being mounted to a base that allows the housing to rotate side-to-side with respect to the base.

10. An article comprising:
a glove adapted to fit over at least a majority of a hand of a wearer; and
a lighting mechanism attached to the glove, the lighting mechanism comprising a housing having a set of lights that are mounted to pivot vertically with respect to the housing, the housing having a power source for the set of lights, and the housing being connected to a base to allow the housing and the horizontal array of lights to pivot horizontally.
